(19) United States
(12) Patent Application Publication
(10) Pub. No.: US 2019/0150476 A1
(43) Pub. Date: May 23, 2019

(54) A PROCESS FOR PREPARING A SHELF-STABLE PROTEIN SNACK

(71) Applicant: NESTEC S.A., Vevey (CH)

(72) Inventor: Albert Kurnia, Konstanz (DE)

(21) Appl. No.: 16/091,303

(22) PCT Filed: Apr. 3, 2017
(86) PCT No.: PCT/EP2017/057871

§ 371 Date: Oct. 4, 2018

(30) Foreign Application Priority Data
Apr. 6, 2016 (EP) 16163955.4

(51) Int. Cl. A23J 3/26; A23J 3/22; A23J 3/16; A23J 3/18; A23L 11/00; A23K 10/30; A23K 20/147; A23K 20/158; A23K 20/163; A23K 40/25; A23K 50/40; A23P 30/25

(52) U.S. Cl. CPC A23J 3/26; A23J 3/227; A23J 3/16; A23J 3/18; A23L 11/07; A23K 10/30; A23V 2002/00; A23K 20/158; A23K 20/163; A23K 40/25; A23K 50/40; A23P 30/25; A23K 20/147

(57) ABSTRACT

The invention generally relates to a process for preparing a shelf-stable protein snack. More specifically the invention relates to a process for preparing a shelf-stable protein snack with a fibrous appearance and a crunchy texture.

The invention generally relates to a process for preparing a shelf-stable protein snack. More specifically the invention relates to a process for preparing a shelf-stable protein snack with a fibrous appearance and a crunchy texture.

In recent years, it has become common for consumers to choose foods that are convenient and tasty. However, convenient or ready-to-eat foods tend to be nutritionally unbalanced as they are high in fat and short-chain carbohydrates e.g. refined sugars, and low in dietary fiber and protein. In particular, it is appreciated that the high fat and low dietary fiber level of these convenient foods can contribute to obesity and various chronic diseases, such as coronary heart disease, stroke, diabetes, and certain types of cancer. It is well known that the primary nutritional features of meat is its protein content. However, the production of meat is relatively inefficient in terms of feed input to food output. Accordingly, high protein snacks can achieve a desired protein content using inexpensive by-products from certain crops such as soybeans. Furthermore, some individuals abstain from the consumption of meat for any of a variety of reasons. Moreover, many pet owners feed or wish to feed meatless diets to their companion animals.

It is well known that by supplementing foods with increased levels of dietary fiber and protein, taste can be seriously compromised as off-flavors result in a chalky and bland taste. In addition to the challenges associated with improving taste, it is known that increasing a food's protein level typically results in the loss of the desirable product texture that consumers expect. This is especially critical for snack foods. The loss of desirable texture typically results in products, such as high protein and fiber health bar snacks that are described by consumers as having an unpleasant stickiness and/or grittiness.

Hence, there is an existing need in the art and industry to provide a better solution for shelf-stable protein snacks for humans or animals such as pets having a fibrous appearance with a crunchy texture. The shelf-stable protein snacks for humans or animals such as pets having a fibrous appearance as dried real meat with a crunchy texture. There are no shelf-stable protein snacks on the market having such fibrous appearance as dried real meat with a crunchy texture.

The object of the present invention is to improve the state of the art or at least provide an alternative for a shelf-stable protein snacks: i) a shelf-stable protein snack for humans or animals such as pets; ii) a shelf-stable protein snack with a high protein content; iii) a shelf-stable protein snack with a protein content above 40 wt %; iv) a shelf-stable protein snack having a fibrous appearance with a crunchy texture; v) a shelf-stable protein snack having a fibrous appearance as dried real meat; vi) a shelf-stable protein snack having a fibrous appearance having starch or starch flour in a low amount; vii) a shelf-stable protein snack having a fibrous appearance without having starch or starch flour; viii) a shelf-stable protein snack having a fibrous appearance having oil, fat or a combination thereof in the resulting snack using starch or starch flour in a low amount; ix) a shelf-stable protein snack having a fibrous appearance having oil, fat or a combination thereof in the resulting snack without using starch or starch flour; x) a shelf-stable protein snack having a crunchy texture; xi) a shelf-stable protein snack having a fibrous appearance as dried real meat with a crunchy texture.

The object of the present invention is achieved by the subject matter of the independent claims. The dependent claims further develop the idea of the present invention.

Accordingly, the present invention provides in a first aspect a process for preparing a shelf-stable protein snack, the process comprising the steps of:
a) feeding an extruder barrel (4) with 40-70 wt % water and 15-35 wt % plant protein and 0-4 wt % starch and/or flour;
b) injecting 0-15 wt % liquid oil, fat or a combination thereof into the extruder barrel (4) at a location down-stream of the feeding location of step a);
c) extruding the mixture through a cooling die (7);
d) cutting (10) and drying (11) the extruded mixture.

In a second aspect, the invention pertains to a shelf-stable protein snack obtainable by the process comprising the steps of:
a) feeding an extruder barrel (4) with 40-70 wt % water and 15-35 wt % plant protein and 0-4 wt % starch and/or flour;
b) injecting 0-15 wt % liquid oil, fat or a combination thereof into the extruder barrel (4) at a location down-stream of the feeding location of step a);
c) extruding the mixture through a cooling die (7);
d) cutting (10) and drying (11) the extruded mixture.

It has been surprisingly found by the inventors that by using the above mentioned process a shelf-stable protein snack having a fibrous appearance and a crunchy texture can be obtained. Due to the fibrous appearance the obtained vegetarian shelf-stable protein snack looks similar to dried real meat. The process of the present disclosure allows the continuous production of a shelf-stable protein snack that has the fibrous appearance of real dried meat with a crunchy texture using extrusion technology. It has now been found by the inventors that injecting oil (5) into the extruder barrel (4) at a location down-stream of the feeding location of the plant protein and water allows having oil, fat or a combination thereof in the resulting composition. The fibrous shelf-stable protein snack produced from these processes can be further enhanced by adding flavouring systems, fillers, colouring, and/or texturization agent and can be fortified to improve the nutritional value of the product. It results in a shelf-stable protein snack having the fibrous appearance of real dried, texture and taste of meat and having 0-15 wt % of oil, fat or a combination thereof in the shelf-stable protein snack.

In case oil or fat or a combination thereof is required in the final product a better fibrous product is achieved through the oil injection down-stream of the feeding location of the plant protein and water high shear within the extruder barrel. In addition many flavour and/or fortification compounds are soluble within oil but not within water. Therefore it is a very convenient way to introduce such compounds within the composition. The oil injection further reduces the need to use starch and/or flour, which is normally responsible to absorb the oil for better processing. In a protein snack high amount of starch and/or flour are perceived with a negative mouth feeling and a cereal taste and aroma which are not pleasant for the consumer. In addition for high protein snacks carbohydrates are avoided due to the nutritional value and/or diets the consumer takes care.

All percentages expressed herein are by weight of the total weight of the shelf-stable protein snack unless expressed otherwise.

The terms “food,” “food product” and “food composition” mean a product or composition that is intended for ingestion by an animal, including a human, and provides at least one nutrient to the animal or human. The present disclosure is not limited to a specific animal. The term “pet food” means any composition intended to be consumed by a pet.

The term “pet” means any animal which could benefit from or enjoy the compositions provided by the present disclosure. For example, the pet can be an avian, bovine, canine, equine, feline, hicrine, lupine, murine, ovine, or porcine animal, but the pet can be any suitable animal. The term “companion animal” means a dog or a cat.

A “non-meat” food product is a composition in which meat (i.e. skeletal tissue and non-skeletal muscle from mammals, fish and fowl) and meat by-products (i.e. the non-rendered clean parts, other than meat, derived from slaughtered mammals, fowl or fish) are completely absent.

By “shelf-stable” is meant that the said protein snack can be safely stored at room temperature in a sealed pack. Particularly, the protein snack can be safely stored for at least 2 months, preferably for at least 6 months, preferably for at least 9 months, more preferably for at least 12 months at a room temperature of 25° C. Within the said shelf-stable period, the protein snack maintains its organoleptic stability as well as its microbiological safety. During that period the protein snack remains its described fibrous appearance and crunchy texture functionality.

“Extrusion” is a process used to create objects of a fixed cross-sectional profile. A material is pushed or pulled through a die of the desired cross-section. The two main advantages of this process over other manufacturing processes are its ability to create very complex cross-sections, and to prepare products that are brittle, because the material only encounters compressive and shear stresses. High-moisture extrusion is known as wet extrusion. Extruders typically comprise an extruder barrel within which rotates a close fitting screw. The screw is made up of screw elements, some of which are helical screw threads to move material through the extruder barrel. Material is introduced into the extruder barrel toward one end, moved along the extruder barrel by the action of the screw and is forced out of the extruder barrel through a nozzle or die at the other end. The rotating screw mixes and works the material in the barrel and compresses it to force it through the die or nozzle. The degree of mixing and work to which the material is subjected, the speed of movement of the material through the extruder barrel and thus the residence time in the extruder barrel and the pressure developed in the extruder barrel can be controlled by the pitch of the screw thread elements, the speed of rotation of the screw and the rate of introduction of material into the extruder barrel. The extruder barrel comprises multiple extruder barrel sections which are joined end to end. Multiple extruder barrel sections are required to carry out different processes involved in extrusion such as conveying, kneading, mixing, devolatilizing, metering and the like. Each extruder barrel section comprises a liner which is press fit into an extruder barrel casing, and heating and cooling elements are provided to regulate temperature of extruder barrel section within permissible range. The total length of an extrusion process can be defined by its modular extrusion barrel length. An extruder barrel is described by its unit of diameter. A “cooling die” is cooling the extruded product to a desired temperature.

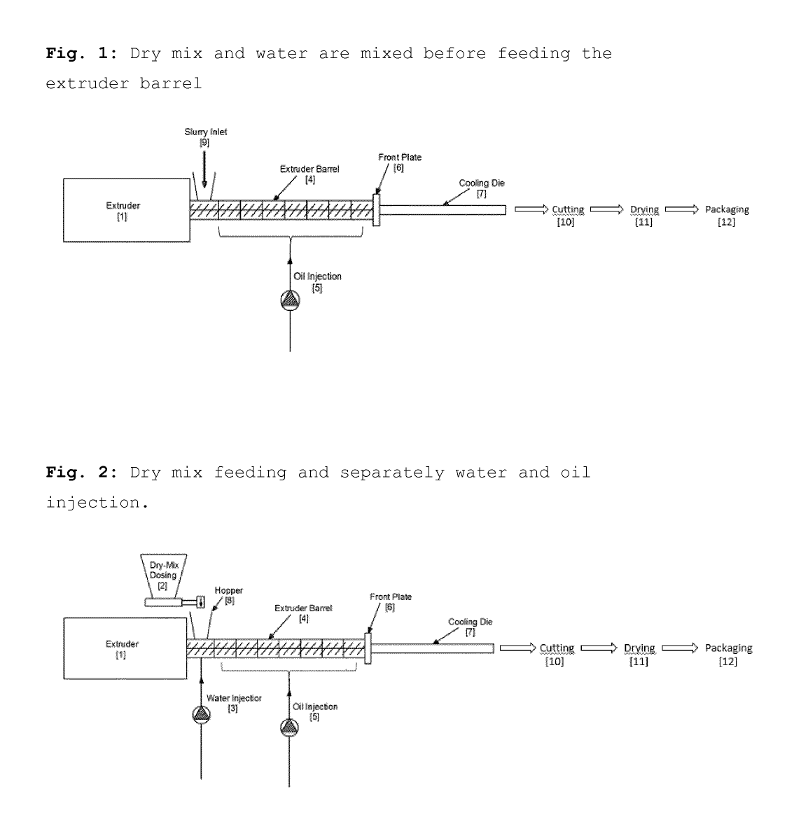

As generally illustrated in FIG. 1, the present disclosure provides a process for producing shelf-stable protein snack. The process can comprise a) feeding an extruder barrel (4) with 20-45 wt % plant protein and 50-70 wt % water and 0-4 wt % starch and/or flour; b) injecting 0-15 wt % liquid oil, fat or a combination thereof into the extruder barrel (4) at a location down-stream of the feeding location of step a); extruding the mixture through a cooling die (7); cutting (10) and drying (11) the extruded mixture.

Further ingredients selected from flavouring, filler and/or optionally fortification compounds can be added to plant protein when feeding the extruder in step a).

In a further embodiment water might be mixed to a dry plant protein before feeding the extruder barrels through a slurry inlet (9).

In a further embodiment plant protein in the form of a dry powder is added to the extruder barrel (4) and water is injected (3) separately. The mixing of the dry plant protein and water is done within the extruder barrel through the mechanical energy forced. Therefore it is not necessary to form a dough of the plant protein and water before feeding the extruder barrel.

The location of injecting the liquid oil or fat (5) is at a location down-stream of the feeding location of the plant protein at any location, preferably within the second half part of the total length of the extruder barrel (4).

The term “plant protein” includes “plant protein isolates” or “plant protein concentrates” or combination thereof. The person skilled in the art knows how to calculate the amount of plant protein within a plant protein concentrate or plant protein isolate.

The term “plant protein concentrate” as used herein is a plant material having a protein content of from about 65% to less than about 90% plant protein on a moisture-free basis. Plant protein concentrate also contains plant fiber, typically from about 3.5% up to about 20% by weight on a moisture-free basis.

The term plant protein isolate as used herein is a plant material having a protein content of at least about 90% plant protein on a moisture free basis.

Plant protein include plant protein concentrate or plant protein isolate from pea protein, corn protein (e.g., ground corn or corn gluten), wheat protein (e.g., ground wheat or wheat gluten such as vital wheat gluten), potato protein, legume protein such as soy protein (e.g., soybean meal, soy concentrate, or soy isolate), rice protein (e.g., ground rice or rice gluten), barley protein, algae protein, canola protein or combinations thereof. Preferably the plant protein is wheat gluten, more preferably the plant protein is a mix from soy protein and wheat gluten, more preferably the plant protein is soy protein.

In a further embodiment, the shelf-stable protein snack of the invention comprises plant protein within step a) in the amount of 15-35 wt %, preferably 17-32 wt %, preferably 17-30 wt %, preferably 17-28 wt %, preferably 18-24 wt %.

In a further embodiment, the shelf-stable protein snack of the invention comprises soy protein within step a) in the amount of 15-35 wt %, preferably 17-32 wt %, preferably 17-30 wt %, preferably 17-28 wt %, preferably 18-25 wt %.

In a further embodiment, the shelf-stable protein snack of the invention comprises soy protein and wheat gluten within step a) in the amount of 15-35 wt %, preferably 17-32 wt %, preferably 17-30 wt %, preferably 17-28 wt %, preferably 18-25 wt %.

In a further embodiment, the shelf-stable protein snack of the invention comprises water within step a) in the amount of 40-70 wt %, preferably 45-70 wt %, preferably 45-65 wt %, preferably 50-70 wt %, preferably 50-65 wt %, preferably 55-65 wt %.

The term liquid oil, fat or combination thereof include soybean oil, corn oil, sunflower oil, high oleic sunflower oil, olive oil, canola oil, safflower oil, peanut oil, palm oil, cottonseed oil, coconut oil, almond oil, hazelnut oil, rape seed oil, fractionated palm fat, fully or partially hydrogenated or inter-esterified palm oil and combinations thereof. Preferably the liquid oil is sunflower oil. In a further embodiment the shelf-stable protein snack comprises the oil and/or fat within step b) in an amount of 0-15 wt %, preferably 0.1-15 wt %, preferably 2-15 wt %, preferably 2.5-15 wt %, preferably 2-10 wt %, preferably 2.5-10 wt %, preferably 2-8 wt %, preferably 2.5-8 wt %, more preferably 2-5 wt %; more preferably 2.5-5 wt %. In a further embodiment the shelf-stable protein snack comprises sunflower oil in an amount of 0-15 wt %, preferably 0.1-15 wt %, preferably 2-15 wt %, preferably 2.5-15 wt %, preferably 2-10 wt %, preferably 2.5-10 wt %, preferably 2-8 wt %, preferably 2.5-8 wt %, more preferably 2-5 wt %; more preferably 2.5-5 wt %.

The term “flavouring” in the context of this invention includes salt, flavouring agents, acids, taste enhancing ingredients, herbs, spices, vegetables or mixtures thereof, which are suitable for being used in a food product. Taste enhancing ingredients may be provided by monosodium glutamate (MSG) and/or yeast extract etc. Salt refers to any suitable alkali metal salt or mixture thereof. The salt used in the composition of this invention is typically, but not limited to, sodium chloride. For example, potassium chloride may be used or any low-sodium product having a taste impression of sodium chloride may be used, as long as the taste in the end formulation is acceptable. Acids may be provided by vinegar, lactic acid, citric acid or combination thereof.

In a further embodiment, the shelf-stable protein snack of the invention comprises flavouring in the amount of 0.5-20 wt %, preferably 0.5-15 wt %, preferably 0.5-10 wt %, preferably 2-10 wt %, preferably 2-8 wt %, preferably 3-8 wt %.

The term “filler” in the content of this invention includes carbohydrates. Carbohydrates may be provided by starches, flours, sugars, maltodextrins, glucose syrups etc., preferably maltodextrin. Starches and/or flours include those from rice, wheat, corn, barley, and sorghum, potato, cassava, sweet potato, arrowroot, yam, pea, chickpea, mung beans or lentil or any combination thereof.

In a further embodiment, the shelf-stable protein snack of the invention comprises fillers in the range 0.5 to 10 wt %, 0.5-8 wt %, preferably 0.5-7 wt %, preferably 1-10 wt %, preferably 1-8 wt %, preferably 1-7 wt %, preferably 2-7 wt %, preferably 0.5-6 wt %, preferably 0.5-5 wt %, preferably 0.5-4 wt %, preferably 0.5-3 wt %.

In a further embodiment, the shelf-stable protein snack of the invention comprises starch and/or flour as filler in the range 0-7 wt %, preferably 0-6 wt %, preferably 0-5 wt %, preferably 0-4 wt %, preferably 0-3 wt %, preferably 0.1-7 wt %, preferably 0.1-6 wt %, preferably 0.1-5 wt %, preferably 0.1-4 wt %, preferably 0.1-3 wt %, preferably 1-7 wt %, preferably 1-8 wt %, preferably 1-6 wt %, preferably 1-5 wt %.

The dry ingredients can also comprise one or more fortification compounds as vitamins, minerals and iron salts. The term vitamins include Vitamins A, B-complex (such as B-1, B-2, B-6 and B-12), C, D, E and K, niacin, and acid vitamins such as pantothenic acid, folic acid and biotin, preferably vitamin B-12. The term minerals include calcium, iron, zinc, magnesium, iodine, copper, phosphorus, manganese, potassium, chromium, molybdenum, selenium, nickel, tin, silicon or vanadium. The term iron salts include ferric sodium EDTA, reduced iron, ferrous lactate, ferric citrate, ferric pyrophosphate, ferrous sulphate monohydrate or ferric ammonium citrate brown, preferably ferric pyrophosphate.

Specific amounts of fortification compounds will depend on a variety of factors such as the identity of the ingredient; the species of animal; the animal's age, body weight, general health, sex, and diet; the animal's consumption rate; the purpose for which the food product is administered to the animal; and the like. Therefore, the components and their amounts may vary widely.

The dry ingredients can also comprise one or more colours. The term colours include FD&C colors, such as blue no. 1, blue no. 2, green no. 3, red no. 3, red no. 40, yellow no. 5, yellow no. 6, and the like; natural colors, such as caramel coloring, annatto, chlorophyllin, cochineal, betanin, turmeric, saffron, paprika, lycopene, elderberry juice, pandan, butterfly pea and the like; titanium dioxide; and any suitable food colorant known to the skilled artisan.

In a further embodiment, the shelf-stable protein snack has a protein content of at least 40 wt % and a water activity less than 0.6 after drying. In a further embodiment, the shelf-stable protein snack has a protein content between 40 to 80 wt %. In a further embodiment, the shelf-stable protein snack has a water activity less than 0.6 after drying, preferably less than 0.3. In a further embodiment, the shelf-stable protein snack has a protein content between 40 to 80 wt % and a water activity less than 0.6 after drying, preferably less than 0.3.

Referring again to FIG. 1, in case the plant protein is mixed with water before feeding the extruder barrel, the non-meat dough can be transferred, for example by pumping, from the mixing device. In an embodiment, the non-meat dough is transferred directly from the mixing device to the extruder barrel without any other processing or addition or removal of ingredients.

Referring again to FIG. 2, in case the plant protein is added as dry mix (2) to the extruder barrel (4), a hopper (8) might be used. Water is added separately (3) to the extruder barrel (4).

The extruder barrels are heated to a temperature of between 70 to 300° C., preferably 80 to 180° C., preferably 80-150° C. The pressure on the front plate (6) is between 10 to 40 bar, preferably 15 bar. The screw speed is around 200-600 rpm.

During the cooling within the cooling die (7) both the temperature and the pressure are gradually reduced as the heated non-meat dough travels through the cooling device. The dough has moisture and is under elevated temperature, so preferably moisture flashing is controlled to avoid rapid expansion of the food product. Product expansion that is too rapid can disrupt the structure of the texturized food product. However, depending on the desired image of the final food product, some flashing may be required to reduce the temperature of the centre of the food product and/or to expose some of the fibers in the food product. In an embodiment, the extruded mixture undergoes a decrease in pressure at a predetermine rate in the cooling device and/or is subjected to a predetermined final pressure at the end of the cooling device. The extruded mixture has an exit temperature at the end of the cooling die (7) between 40-110° C., preferably between 50-100° C., preferably between 50-95° C., preferably between 50-90° C.

After cooling within the cooling die (7) the extruded mixture can be cut and/or shaped (10) directly in-line or off-line. For example, an exit plate on the cooling die can shape the product as the product departs the cooling die. Each of the exit plates can have one or more orifices that impart a desired shape on the product travelling through the exit plate. Each exit plate is preferably directly attached to a corresponding outlet of the cooling die so that the product exiting the cooling die and being shaped by the exit plate occurs substantially simultaneously as one step.

As another example, one or more grids of static or vibrating knives can be attached after the cooling die. These knife grids can have vertical, horizontal and/or diagonal knives, depending on the shape of the food product to be manufactured. If more defined shapes are required, a cutting die with a more complex design can be fitted to each of the one or more outlets of the cooling die array.

In conjunction with the knife grids or cutting dies, if any, a rotating or similar type cross-cutting device can be attached. This cross-cutting device allows the exiting material to be cut to the required dimension. The speed of the cross-cutter can be automatically controlled depending on product flow rates, for example by a processor.

After cutting the protein snack product is dried (11). The drying is selected from air drying, microwave drying, freeze drying, vacuum belt drying, vacuum oven drying, vacuum microwave drying, vacuum infrared drying, dielectric drying, supercritical drying. In a preferably embodiment of the invention the drying is step is a vacuum drying step. The vacuum drying step helps to retain the desired shape and fibrous structure of the shelf-stable protein snack product. The vacuum drying is selected from vacuum belt drying, vacuum oven drying, vacuum microwave drying, vacuum infrared drying or combinations thereof. After drying the shelf-stable protein snack has a water activity less than 0.6, preferably less than 0.3. In an embodiment the shelf-stable protein snack has a size after drying with the dimension of length 20 to 100 mm, width 5 to 50 mm and thickness 0.1 to 20 mm.

The shelf-stable protein snack can be filled and sealed into a package. Non-limiting examples of suitable packaging types include cans, pouches, glass container, plastic containers.

As used in this specification, the words “comprises”, “comprising”, and similar words, are not to be interpreted in an exclusive or exhaustive sense. In other words, they are intended to mean “including, but not limited to”.

Those skilled in the art will understand that they can freely combine all features of the present invention disclosed herein. In particular, features described for the composition of the present invention may be combined with the process for the preparation of the composition, and vice versa. Further, features described for different embodiments of the present invention may be combined. Further advantages and features of the present invention are apparent from the examples.

### EXAMPLES

The invention is further described with reference to the following examples. It will be appreciated that the invention as claimed is not intended to be limited in any way by these examples.

The examples are describing the preparation of a shelf-stable protein snack by the process of this invention. A dry mix of the plant protein was added through a hopper (8) into the extruder barrel (4) and water is separately injected (3) at room temperature. The extruder barrel (4) is heated within a curve between 80-150° C. Oil is injected (5) within this temperature range within the first quarter of the total length of the extruder barrel (4). The cooling die (7) is cooling the extruded mixture to an exit temperature of 70° C., which is afterwards cutted and dried using a vacuum dryer. The product was made on a Bühler BCTL-42 twin screw extruder from the following materials:

### Example 1

| Ingredient | % (w/w) |
|---|---|
| Water | 50 |
| Wheat Gluten Protein concentrate | 34 |
| Maltodextrin | 3 |
| Liquid plant oil | 4 |
| Starch or Flour | 4 |
| Flavouring | 5 |
| Total Protein content from concentrate | 27 |

### Example 2

| Ingredient | % (w/w) |
|---|---|
| Water | 63 |
| Soy Protein concentrate | 25 |
| Wheat Gluten Protein concentrate | 5 |
| Liquid plant oil | 4 |
| Starch or Flour | 0 |
| Flavouring | 3 |
| Total Protein content from concentrate | 21 |

### Example 3

| Ingredient | % (w/w) |
|---|---|
| Water | 63 |
| Soy Protein concentrate | 30 |
| Liquid plant oil | 4 |
| Starch or Flour | 0 |
| Flavouring | 3 |
| Total Protein content from concentrate | 21 |

### Example 4

| Ingredient | % (w/w) |
|---|---|
| Water | 51 |
| Soy Protein concentrate | 35 |
| Maltodextrin | 1.5 |
| Liquid plant oil | 8 |
| Starch or Flour | 0 |
| Flavouring | 4.5 |
| Protein content from concentrate | 25 |

### Example 5

| Ingredient | % (w/w) |
|---|---|
| Water | 61 |
| Soy Protein concentrate | 31 |
| Liquid plant oil | 4 |
| Starch or Flour | 0 |
| Flavouring | 4 |
| Total Protein content from concentrate | 21 |

The resulted shelf-stable protein snacks from examples 1 to 5 have a fibrous appearance of real meat with a crunchy texture.

1. A process for preparing a shelf-stable protein snack, the process comprising the steps of:
a) feeding an extruder barrel with 40-70 wt % water and 15-35 wt % plant protein and 0-4 wt % starch and/or flour;
b) injecting 0-15 wt % liquid oil, fat or a combination thereof into the extruder barrel at a location down-stream of the feeding location of step a);
c) extruding the mixture through a cooling die;
d) cutting and drying the extruded mixture.

2. The process for preparing a shelf-stable protein snack according to claim 1, wherein 0.1-15 wt %, liquid oil, fat or a combination thereof are injected into the extruder barrel at a location down-stream of the feeding location of step a).

3. The process for preparing a shelf-stable protein snack according to claim 1, wherein the shelf-stable protein snack does not comprise protein from an animal source.

4. The process for preparing a shelf-stable protein snack according to claim 1 further comprises feeding the extruder barrel with flavoring.

5. The process for preparing a shelf-stable protein snack according to claim 4, wherein the amount of flavoring is in the range of 0.5 to 15 wt %.

6. The process for preparing a shelf-stable protein snack according to claim 1, wherein the plant protein is mixed with the water before feeding the extruder barrels.

7. The process for preparing a shelf-stable protein snack according to claim 1, wherein the plant protein is added to the extruder barrel in the form of a dry powder and water is injected separately into the extruder barrel.

8. The process for preparing a shelf-stable protein snack according to claim 1, wherein the plant protein is selected from the group consisting of soy protein or wheat gluten, and a combination thereof.

9. The process for preparing a shelf-stable protein snack according to claim 1, wherein the liquid oil is sunflower oil.

10. The process for preparing a shelf-stable protein snack according to claim 1, wherein the extruder barrel is heated to a temperature between 80-300° C.

11. The process for preparing a shelf-stable protein snack according to claim 1, wherein the extruded mixture has an exit temperature at the end of the cooling die between 50-110° C.

12. A process as claimed in claim 1, wherein the drying is vacuum drying.

13. A shelf-stable protein snack obtainable by a process comprising the steps of:
a) feeding an extruder barrel with 40-70 wt % water and 15-35 wt % plant protein and 0-4 wt % starch and/or flour;
b) injecting 0-15 wt % liquid oil, fat or a combination thereof into the extruder barrel at a location down-stream of the feeding location of step a);
c) extruding the mixture through a cooling die;
d) cutting and drying the extruded mixture.

14. A shelf-stable protein snack of claim 13 wherein the shelf-stable protein snack has a protein content after drying of at least 40 wt %.

15. A shelf-stable protein snack as claimed in claim 13 wherein the shelf-stable protein snack after drying has a water activity less than 0.6.
